(19) United States
(12) Patent Application Publication
(10) Pub. No.: US 2023/0260003 A1
(43) Pub. Date: Aug. 17, 2023

(54) MACHINE LEARNING-BASED ITEM FEATURE RANKING

(71) Applicant: Home Depot Product Authority, LLC, Atlanta, GA (US)

(72) Inventors: Mingming Guo, Atlanta, GA (US); Nian Yan, Dunwoody, GA (US); Xiquan Cui, Atlanta, GA (US); Simon Hughes, Riverside, IL (US); Khalifeh Al Jadda, Suwanee, GA (US)

(21) Appl. No.: 17/417,693

(22) PCT Filed: Jun. 21, 2021
(86) PCT No.: PCT/US2021/038282

§ 371 Date: Jun. 23, 2021

Related U.S. Application Data
(60) Provisional application No. 63/041,150, filed on Jun. 19, 2020.

(51) Int. Cl. G06Q 30/0601

(52) U.S. Cl. CPC G06Q 30/0629

(57) ABSTRACT

A method of determining item features and organizing an interface according to the features includes determining a plurality of features of a plurality of items, the plurality of items accessible through an electronic interface, applying a plurality of machine learning models to the determined features, wherein each of the machine learning models calculates a correlation of each feature to characteristic determinative of user selection on the electronic interface, calculating respective Shapley values of each correlation determined by each of the plurality of machine learning models, determining one or more of the item features that are most strongly correlated with the determinative characteristic according to the respective Shapley values, and causing the electronic interface to be organized according to the determined most strongly correlated item features.

### CROSS REFERENCE TO RELATED APPLICATION

This application claims priority to U.S. provisional application No. 63/041,150, filed Jun. 19, 2020, which application is hereby incorporated by reference in its entirety.

### TECHNICAL FIELD

The instant disclosure relates to machine learning-based determination and output of relevant item features in an electronic interface.

### BACKGROUND

A user may browse an electronic interface, such as a web site or mobile application, to learn about items such as products and services.

### SUMMARY

In a first aspect of the present disclosure, a method is provided. The method includes determining a plurality of features of a plurality of items, the plurality of items accessible through an electronic interface, applying a plurality of machine learning models to the determined features, wherein each of the machine learning models calculates a correlation of each feature to characteristic determinative of user selection on the electronic interface, calculating respective Shapley values of each correlation determined by each of the plurality of machine learning models, determining one or more of the item features that are most strongly correlated with the determinative characteristic according to the respective Shapley values, and causing the electronic interface to be organized according to the determined most strongly correlated item features.

In an embodiment of the first aspect, causing the electronic interface to be organized according to the determined most strongly correlated item features includes one or more of: causing a filter to be provided for each of the determined most strongly correlated item features in the electronic interface; or causing a respective value for each most strongly correlated item feature for each of the plurality of items to be displayed when the items are displayed on the interface.

In an embodiment of the first aspect, the plurality of machine learning models includes: a first model that outputs whether a correlation of each feature to the determinative characteristics is positive or negative, and a second model that provides more accurate calculations of correlation than the first model.

In an embodiment of the first aspect, one or more of: the first model includes a linear regression model, or the second model includes a tree-based algorithm.

In an embodiment of the first aspect, the plurality of machine learning models includes a first model and a second model, wherein the first model provides more accurate correlation calculations than the second model with respect to numerical features, and the second model provides more accurate correlation calculations than the first model with respect to textual features.

In an embodiment of the first aspect, determining a plurality of features of a plurality of items includes determining numerical features of each of the plurality of items, and determining textual features of each of the plurality of items.

In an embodiment of the first aspect, determining textual features of each of the plurality of items includes identifying, for each of the items, in a document associated with the item, zero or more textual strings, each textual string including text indicative of a respective feature, and one or more of: discarding textual strings that are greater than a threshold length; discarding textual strings containing features with greater than a threshold quantity of possible values; or discarding textual strings containing features occurring less than a threshold quantity of times in the plurality of items, and designating features in the identified, non-discarded strings as the textual features.

In an embodiment of the first aspect, the method further includes receiving an interface navigation request from a user of the electronic interface, determining one or more of the plurality of items to be displayed in response to the navigation request, and displaying, in response to the navigation request, the determined one or more of the plurality of items to be displayed, including respective feature values for the determined most strongly correlated item features.

In a second aspect of the present disclosure, a system is provided. The system includes a backend computing system comprising a non-transitory computer-readable memory storing instructions and a processor configured to execute the instructions to determine a plurality of features of a plurality of items, the plurality of items accessible through an electronic interface, apply a plurality of machine learning models to the determined features, wherein each of the machine learning models calculates a correlation of each feature to characteristic determinative of user selection on the electronic interface, calculate respective Shapley values of each correlation determined by each of the plurality of machine learning models, determine one or more of the item features that are most strongly correlated with the determinative characteristic according to the respective Shapley values, and a server in electronic communication with the backend computing system, the server configured to host the electronic interface and to organize the electronic interface according to the determined most strongly correlated item features.

In an embodiment of the second aspect, organizing the electronic interface according to the determined most strongly correlated item features includes one or more of providing a filter for each of the determined most strongly correlated item features in the electronic interface, or providing a respective value for each most strongly correlated item feature for each of the plurality of items when displayed on the interface.

In an embodiment of the second aspect, the plurality of machine learning models includes a first model that outputs whether a correlation of each feature to the determinative characteristics is positive or negative, and a second model that provides more accurate calculations of correlation than the first model.

In an embodiment of the second aspect, one or more of: the first model includes a linear regression model; or the second model includes a tree-based algorithm.

In an embodiment of the second aspect, the plurality of machine learning models includes a first model and a second model, wherein the first model provides more accurate correlation calculations than the second model with respect to numerical features, and the second model provides more accurate correlation calculations than the first model with respect to textual features.

In an embodiment of the second aspect, determining a plurality of features of a plurality of items includes determining numerical features of each of the plurality of items, and determining textual features of each of the plurality of items.

In an embodiment of the second aspect, determining textual features of each of the plurality of items includes identifying, for each of the items, in a document associated with the item, zero or more textual strings, each textual string including text indicative of a respective feature, and one or more of: discarding textual strings that are greater than a threshold length; discarding textual strings containing features with greater than a threshold quantity of possible values; or discarding textual strings containing features occurring less than a threshold quantity of times in the plurality of items, and designating features in the identified, non-discarded strings as the textual features.

In an embodiment of the second aspect, the server is further configured to receive an interface navigation request from a user of the electronic interface, determine one or more of the plurality of items to be displayed in response to the navigation request, and display, in response to the navigation request, the determined one or more of the plurality of items to be displayed, including respective feature values for the determined most strongly correlated item features.

In a third aspect of the present disclosure, a method is provided. The method includes determining a plurality of features of a plurality of items, each item associated with a respective page of an electronic interface, applying a plurality of machine learning models to the determined features, wherein each of the machine learning models calculates a correlation of each feature to characteristic determinative of user selection on the electronic interface, determining one or more of the item features that are most strongly correlated with the determinative characteristic according to the machine learning models, and causing a page of the electronic interface that includes at least two of the plurality of items to be organized according to the determined most strongly correlated item features.

In an embodiment of the third aspect, the method further includes calculating respective Shapley values of each correlation determined by each of the plurality of machine learning models, wherein determining one or more of the item features that are most strongly correlated with the determinative characteristic according to the machine learning models is according to the Shapley values.

In an embodiment of the third aspect, the electronic interface is a website or an application.

In an embodiment of the third aspect, the plurality of machine learning models includes a first model that outputs whether a correlation of each feature to the determinative characteristics is positive or negative, and a second model that provides more accurate calculations of correlation than the first model.

### BRIEF DESCRIPTION OF THE DRAWINGS

FIG. 1 is a block diagram view of an example system for providing an electronic user interface and organizing the interface according to features of items listed in the interface.

FIG. 2 is a flow chart illustrating an example method of determining item features for organizing an electronic user interface.

FIG. 3 is a flow chart illustrating an example method of providing an electronic user interface and organizing the interface according to item features.

FIG. 4 is a flow chart illustrating an example method for determining item features respective of a plurality of items.

FIG. 5 is a flow chart illustrating an example method of calculating a plurality of correlations of a plurality of item features to a determinative characteristic according to a plurality of machine learning models.

FIG. 6 is a diagrammatic view of an example user computing environment.

### DETAILED DESCRIPTION

Item feature recommendations enable users to select the correct items, such as products and services, when searching or browsing an electronic interface, such as a website or mobile application. For a customer, selecting the item that has the best trade-off between a characteristic determinative of user action (referred to herein as a “determinative characteristic”), such as price, and feature set can be time-consuming. Users can be overwhelmed by available choices. The features that most differentiate a particular item—that is, most strongly linked with the determinative characteristic—are typically not information determined by, or provided by, the interface for the user's convenience. This disclosure includes use of interpretable machine learning methods to tackle this problem. The problem may be formulated as a determinative characteristic-driven supervised learning problem to discover the product features that best explain the determinative characteristic value of an item in a given item category.

The teachings of the instant disclosure may be applied to improve the functionality of a server hosting a website by more accurately determining the relevant features of an individual item or many items within a given category. Relevant features can be arranged more prominently for the user's review, can be placed more prominently in a filter list, or can be given greater weight when organizing search result rankings, or can be otherwise used to arrange the interface for the user, thereby simplifying user navigation and reducing the server's load of searches and page loads.

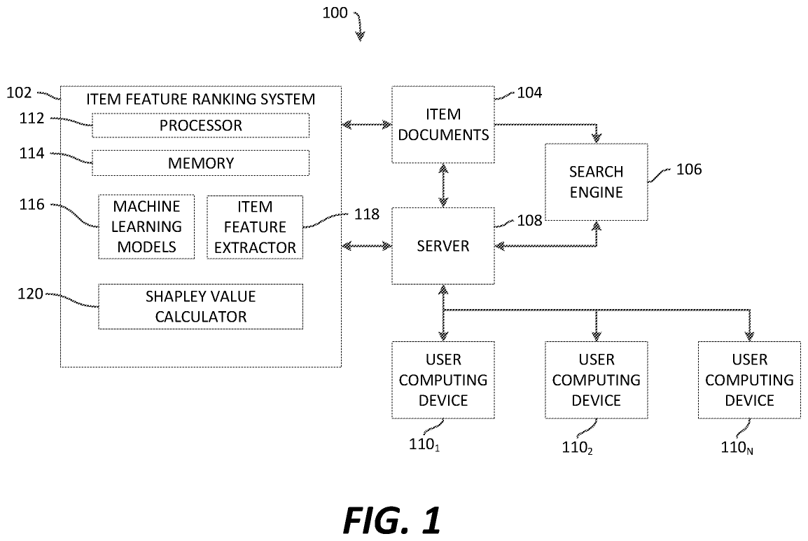

Referring to the figures, in which like reference numerals refer to the same or similar features in the various views, FIG. 1 is a block diagram view of an example system 100 for providing an electronic user interface and organizing the interface according to features of items listed in the interface. The system 100 may include an item feature ranking system 102, a repository of item documents 104, a search engine 106, a server 108, and a plurality of user computing devices 1101, 1102, . . . 110N (which may be referred to individually as a user computing device 110 or collectively as the user computing devices 110).

The server 108 may be configured to host or otherwise provide an electronic user interface through which a plurality of items may be made available for informational browsing and/or purchase by the user computing devices 110. The items may be products and/or services. The electronic user interface may be or may include a website or an application, in some embodiments.

The server 108 may be in electronic communication with the user computing devices 110 and may provide the electronic user interface to the user computing devices 110. The server 108 may receive user navigation requests respective of the interface, such as search requests, requests for specific item pages, requests for landing or multi-item pages, or other navigation requests. In response to such requests, the server 108 may provide one or more pages of the interface to the user computing devices 110, with each of the one or more pages organized in one or more respects according to features of the items included on the provided page, as will be described in greater detail herein.

The server 108 may be in electronic communication with the repository of item documents 104. The repository 104 may be a database, for example. The item documents may be product information pages respective of products available for browsing or purchase on the interface provided by the server 108, for example. Accordingly, the server 108 may provide the item documents directly on the interface, or more provide one or more pages including information from a plurality of item documents, such as landing pages, search result pages, item category or compilation pages, and the like.

The search engine 106 may be configured to search the item documents and other information available on the interface in response to user search queries entered on the interface. In response to a search query, the search engine 106 may return a set of search results that includes one or more items. The item feature ranking system 102 may cause the search results to be organized according to an item feature ranking, in some embodiments.

The item feature ranking system 102 may be or may include a backend computing system in electronic communication with the server 108. The item feature ranking system 102 may determine and provide one or more ranked lists of features to the server 108 to enable the server 108 to organize the interface according to the feature rankings. The item feature ranking system 102 may include a processor 112 and a non-transitory, computer-readable memory 114. The memory 114 may store instructions that, when executed by the processor 112, cause the item feature ranking system 102 to perform one or more of the processes, methods, algorithms, etc. of this disclosure.

One or more functional modules 116, 118, 120 may be embodied in the instructions stored in the memory 114. The functional modules 116, 118, 120 may include one or more machine learning models 116, an item feature extractor 118, and a Shapley value calculator 120. The item feature extractor 118 may receive item documents from the repository of item documents 104 as input and may out one or more features of the items. The one or more machine learning models 116 may receive the item features as input, along with a characteristic determinative of user behavior on the interface, and may output one or more values of a respective correlation between each item feature and the determinative characteristic. The Shapley value calculator 120 may determine respective Shapley values for the correlation values determined by the one or more machine learning models 116. The Shapley values, or a mathematical combination or derivation of the Shapley values, may be used by the item feature ranking system 102 to rank the features of the items.

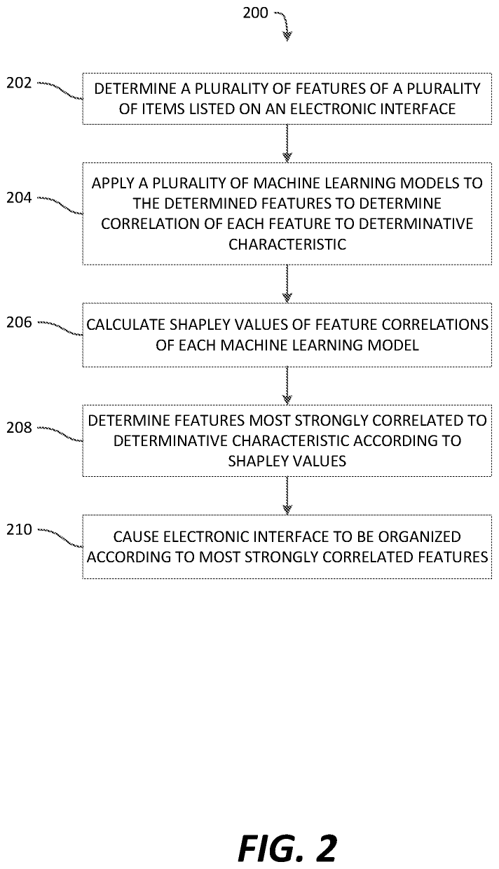

FIG. 2 is a flow chart illustrating an example method 200 of determining item features for organizing an electronic user interface. The method 200, or one or more portions of the method 200, may be performed by the item feature ranking system 102 of FIG. 1, in some embodiments.

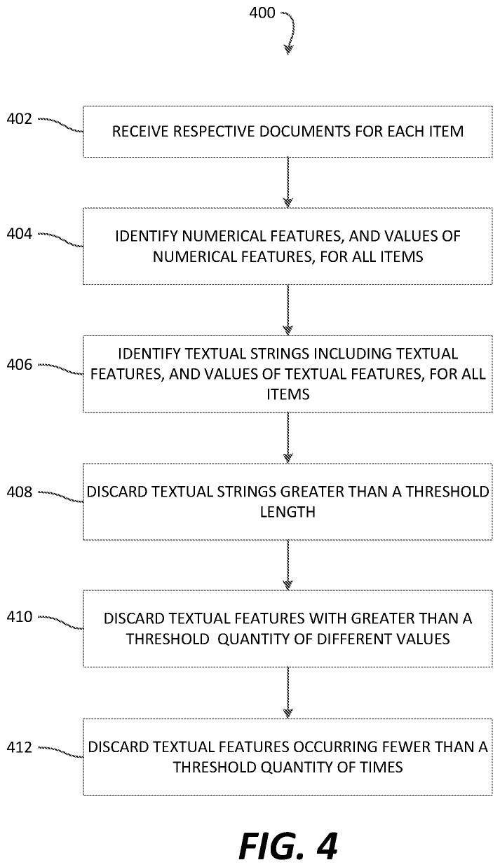

The method 200 may include, at block 202, determining a plurality of features of a plurality of items listed on an electronic interface. A detailed example of block 202 is disclosed in conjunction with the method 400 of FIG. 4. Briefly, determining a plurality of features of a plurality of items may include extracting numerical features (i.e., features that are inherently quantified, such as dimensions) and textual features (i.e., features that are not inherently quantified, such as colors or subjective descriptions such as “quiet”) (textual features may also be referred to herein as “categorical” features) from documents associated with the items, along with the values of each feature for each item. Certain features may be discarded, such as textual features that are unlikely to be reliably associated with user actions, including textual features with a low quantity of instances or a high quantity of values.

In some embodiments, the actions performed at block 202 may be category-specific. That is, a respective feature extraction schema may be applied for each item category to the plurality of items. Accordingly, in some embodiments, the method 200 may include, at block 202, applying one or more respective category-specific feature extraction schemes to a respective plurality of items in each of two or more item categories.

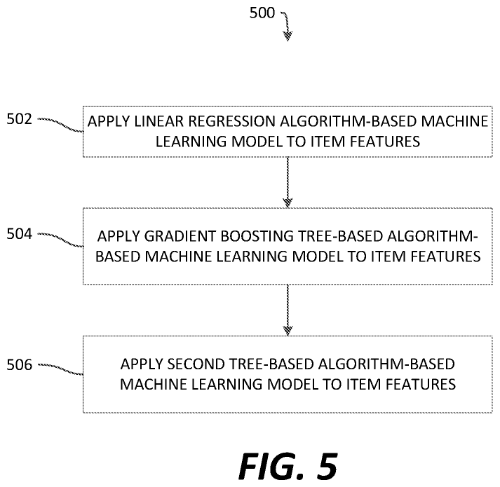

The method 200 may further include, at block 204, applying a plurality of machine learning algorithms to the determined item features to determine one or more correlations of the item features to a characteristic determinative of user behavior. A detailed example of block 204 is disclosed in conjunction with the method 500 of FIG. 5. Briefly, in some embodiments, a plurality of machine learning models may be applied in parallel to the item features. Each machine learning model may be trained on learning data that includes item features and determinative characteristic values. Each model may be trained to identify respective correlations between various item features and one or more determinative characteristics. Accordingly, each machine learning model may output a respective correlation between each feature and a determinative characteristic. The machine learning models may utilize different algorithm types relative to each other, in some embodiments, such that the different machine learning models have varying strengths relative to each other. For example, in some embodiments, one machine learning model may be more accurate in identifying the correlation of numerical features to the determinative characteristic than the other models, one model may be more accurate in identifying the correlation of categorical features to the determinative characteristic than the other models, and one model may determine whether one or more correlations are positive or negative (e.g., whether an increase in a feature value causes an increase or decrease in the determinative characteristic value), whereas other models may not distinguish between positive and negative correlations.

In some embodiments, the actions performed at block 204 may be category-specific. That is, a respective set of one or more models may be trained for each of a plurality of item categories, in reflection of different item categories having different typical features and/or different features that strongly correlate with a given determinative characteristic. Accordingly, in some embodiments, the method 200 may include applying one or more respective category-specific models to a respective plurality of items in each of two or more item categories.

The method 200 may further include, at block 206, calculating Shapley values of the feature correlations determined by the machine learning models. As known in the art, Shapley values are weights assigned to different strategies (here, different combinations of feature values) to maximize overall rewards (here, the highest movement of a determinative characteristic value based on feature value movements) across those possible strategies. Instead of Shapley values, another set of weights may be calculated that maximize the overall benefit or gain of the various item features (e.g., the correlations of those features with a determinative characteristic).

The method 200 may further include, at block 208, determining one or more of the item features that are most strongly correlated with the determinative characteristic according to the Shapley values. For example, in some embodiments, each Shapley value of a given feature may be mathematically combined. In some embodiments, an average of the Shapley values of a given feature may be calculated, for each feature. The averaged Shapley values of each feature may then be compared to each other to determine the features most strongly correlated with the determinative characteristic. As a result of block 208, the features determined in block 202 may be ranked relative to one another.

The method may further include, at block 210, causing the electronic interface to be organized according to the most strongly correlated item features. Organizing the interface according to the most strongly correlated item features may include, for example, causing the relevant values of those most strongly correlated item features to be displayed when the corresponding items are displayed to the user in the interface. Additionally or alternatively, organizing the interface according to the most strongly correlated item features may include providing filters respective of each of those most strongly correlated features.

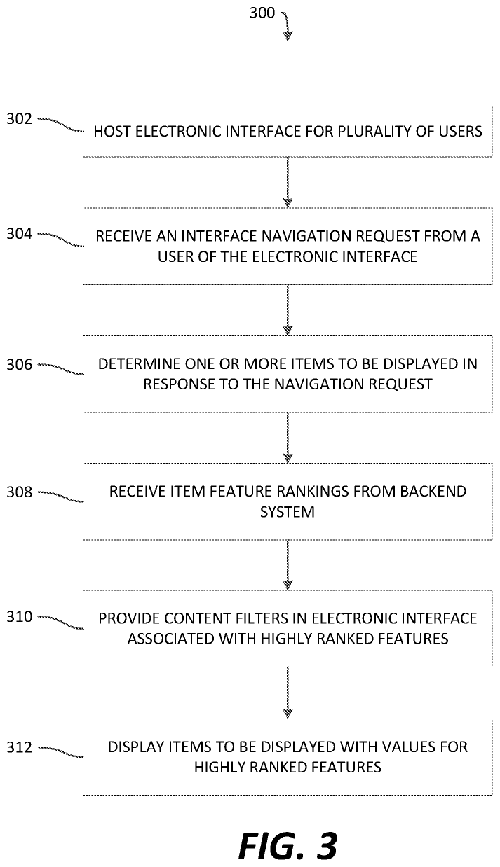

FIG. 3 is a flow chart illustrating an example method 300 of providing an electronic user interface and organizing the interface according to item features. The method 300, or one or more aspects of the method 300, may be performed by the server 108 of FIG. 1, in some embodiments.

The method 300 may include, at block 302, hosting an electronic interface for a plurality of users. The electronic interface may be a website or mobile application, in some embodiments. The server 300 may organize the interface and populate the interface with items and information respective of those items (e.g., information retrieved from the item information repository of FIG. 1). The server 300 may organize the interface by transmitting data to a browser or client application, which data causes the interface to be organized according to the server's instructions.

The method 300 may further include, at block 304, receiving an interface navigation request from a user of the electronic interface. The interface navigation request may be an input by the user in the interface. The interface navigation request may be, for example, a search query, a selection of a link or text entry to navigate to a particular page of the interface, or another user input for navigating within the interface.

The method 300 may further include, at block 306, determining one or more items to be displayed in response to the navigation request. In embodiments where the user navigation request includes a search query, block 306 may include providing the search query to a search engine, receiving results to the search query from the search engine, and identifying the items included in the search results. In embodiments where the user navigation request includes a user click on a link or text entry to navigate to a particular page of the interface for specific types of items, block 306 may include retrieving items, and information respective of those items, that match the type of item requested by the user. For example, at block 306, all items in a particular category identified by the user may be determined, or all items with a specific feature identified by the user, or all items included on a pre-arranged page to which the user instructs navigation.

The method 300 may further include, at block 308, receiving an item feature ranking from a backend system. The backend system may calculate and update item feature rankings periodically. The feature ranking may be received from the item feature ranking system of FIG. 1, for example. The feature rankings may be received in response to determining items to be displayed at block 306, in some embodiments. In other embodiments, the feature rankings may have been received before block 306. In some embodiments, the feature rankings received may be limited to features relevant to the items to be displayed. The interface may be organized according to the feature rankings.

The method 300 may further include, at block 310, providing content filters in the electronic interface associated with highly ranked item features. For example, if a width of an item is a highly-ranked feature, a filter may be provided for the user to filter the items displayed in the interface to display only items with one or more desired width values, or one or more ranges of width values. If color is a highly-ranked feature, a filter may be provided for the user to filter the items displayed to only items of one or more user-desired colors. In response to user selection of one or more of the filters, the interface may further be organized to display items that meet the user's filtering criteria, and not items that do not meet the user's filtering criteria.

The method 300 may further include, at block 312, displaying the one or more items to be displayed to the user, including feature values respective of the highly ranked features. That is, the display of each item may include the item's values for the highly ranked features. Additional features and their values may be included, as well, for each displayed item, in some embodiments. Accordingly, the features rankings received at block 308 may be used to set the default features that are displayed for each item in the interface, or the default order of those features.

In addition to or instead of blocks 310 and 312, other processes for organizing the interface according to the feature rankings may be applied in method 300.

FIG. 4 is a flow chart illustrating an example method 400 for determining item features respective of a plurality of items. The method 400, or one or more portions of the method 400, may be performed by the item feature ranking system 102 of FIG. 1, in some embodiments.

The method 400 may include, at block 402, receiving one or more respective documents for each of the plurality of items. The documents may be received from the repository of item documents of FIG. 1, for example. In some embodiments, each item may be associated with its own respective one or more documents.

The method 400 may further include, at block 404, identifying numerical features, and the values of the numerical features, for each of the plurality of items. Pattern recognition may first be performed to discover the basic pattern for each feature (e.g., the labels used, order of information, format of the feature value (such as where a unit appears relative to the value), etc.) for each feature. Rules may be developed for each pattern, and the rules may be applied to each item document to identify the numerical features and values of those features included in the item documents for each item. Identifying numerical features may be performed according to category-specific pattern recognition and rules, in some embodiments.

The method 400 may further include, at block 406, identifying zero or more textual strings including text indicative of respective features, and values of those textual features, for each of the plurality of items. Identifying textual features may be performed according to category-specific pattern recognition and rules, in some embodiments. For example, text content that does not include a numerical feature may be initially identified as a textual string indicative of a feature at block 406, in some embodiments.

The method 400 may further include, at block 408, discarding textual strings that are greater than a threshold length. As a result, only categorical features described with a low number of words may be maintained, in some embodiments. Categorical features with overly-long descriptions may generally be associated with features that are less meaningful to user navigation, in some embodiments. The discarding of block 408 may occur as feature strings are identified, in some embodiments.

The method 400 may further include, at block 410, discarding textual features with greater than a threshold quantity of different values. The discarding of block 410 may occur after all item documents have been analyzed for categorical features, in some embodiments, or once the number of values for a given quantity exceeds its threshold. The discarding at block 410 may be performed in order to avoid features that, by virtue of an overabundance of values, may not have any particular values having a statistically-significant number of occurrences.

The method 400 may further include, at block 412, discarding textual features occurring fewer than a threshold quantity of times. The discarding of block 412 may occur after all item documents have been analyzed for categorical features. The discarding at block 412 may be performed in order to avoid features that may not have a statistically-significant number of occurrences.

Textual features included in strings not discarded at block 408, 410, or 412 may be designated as categorical features, in some embodiments.

As a result of the method 400, all features of all items included in the items documents may be determined, along with the values of the features.

FIG. 5 is a flow chart illustrating an example method 500 of calculating a plurality of correlations of a plurality of item features to a determinative characteristic according to a plurality of machine learning models. The method 500, or one or more portions of the method 500, may be performed by the item feature ranking system 102 of FIG. 1, in some embodiments.

The method 500 may include, at block 502, applying a first machine learning model based on a linear regression algorithm to the item features. The linear regression-based model may advantageously output a direction of correlation between each feature and the determinative characteristic. That is, the linear regression model may output whether an increase in a feature value leads to an increase or decrease of the determinative characteristic value, and whether a decrease in the feature value leads to an increase or decrease in the determinative characteristic value. In a linear regression model, each determined feature is assigned a weight and the weight is updated in the learning process to minimize the prediction error of the model. Linear regression can learn the feature direction by increasing or decreasing the weight for that feature while observing the changing direction of the target variable determinative characteristic. When changing the weight for a feature to determine direction of correlations, the weights of other features may be kept constant.

The method 500 may further include, at block 504, applying a second machine learning model based on a gradient boosting tree-based algorithm to the item features. The second machine learning model may be or may include, in some embodiments, a LightGBM algorithm. The first machine learning model may learn feature importance by computing the average gain of the feature when it is used to partition the data. In some embodiments, the second machine learning model may output very accurate correlations (e.g., more accurate than the first model applied at block 502 or the third model applied at block 506) with respect to numerical features.

The method 500 may further include, at block 506, applying a third machine learning model based on a second tree-based algorithm to the item features. The model may be or may include, for example, a CatBoost algorithm, or another sophisticated tree-based algorithm that can handle and learn feature importance of categorical features as a whole without the need to split them. The third model may support text features as well. For example, ‘top material’ may be a primary feature to drive the price for the ‘Bathroom Vanities with Tops’ category; a categorical feature with string values. The third model may learn feature importance according to the average gain in the tree splitting process. In addition, the third model may learn the feature importance for categorical features by transforming them into numerical features before each split is selected in the tree and using various statistics on the combinations of categorical and numerical features as well as combinations of categorical features.

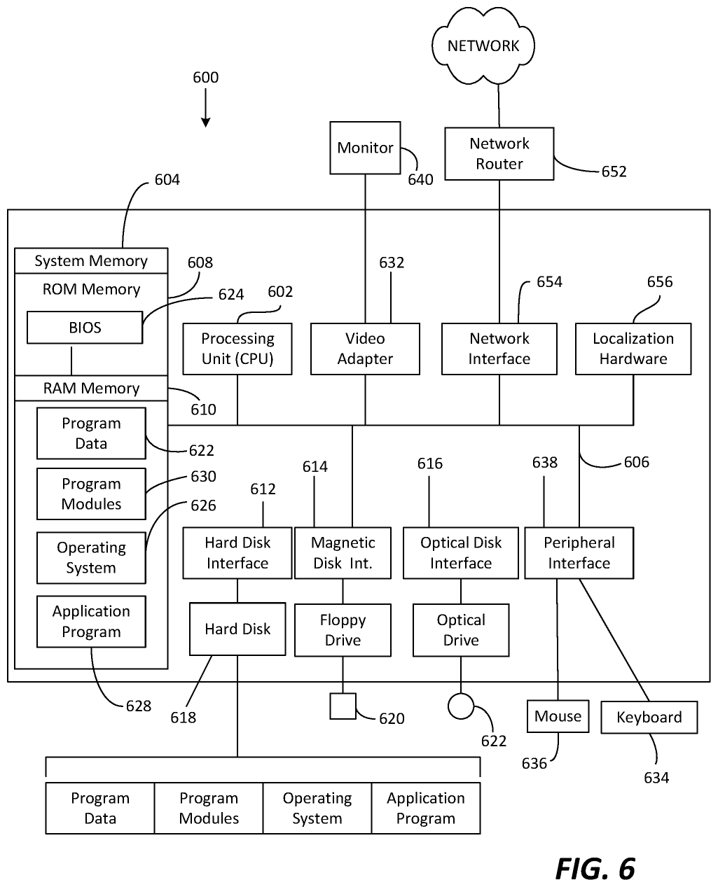

FIG. 6 is a diagrammatic view of an example embodiment of a user computing environment that includes a general purpose computing system environment 600, such as a desktop computer, laptop, smartphone, tablet, or any other such device having the ability to execute instructions, such as those stored within a non-transient, computer-readable medium. Furthermore, while described and illustrated in the context of a single computing system 600, those skilled in the art will also appreciate that the various tasks described hereinafter may be practiced in a distributed environment having multiple computing systems 600 linked via a local or wide-area network in which the executable instructions may be associated with and/or executed by one or more of multiple computing systems 600. One or more aspects of the system 100 may comprise a computing environment 600, such as but not limited to the item feature ranking system 102, item document repository 104, server 108, and/or user computing devices 110.

In its most basic configuration, computing system environment 600 typically includes at least one processing unit 602 and at least one memory 604, which may be linked via a bus 606. Depending on the exact configuration and type of computing system environment, memory 604 may be volatile (such as RAM 610), non-volatile (such as ROM 608, flash memory, etc.) or some combination of the two. Computing system environment 600 may have additional features and/or functionality. For example, computing system environment 600 may also include additional storage (removable and/or non-removable) including, but not limited to, magnetic or optical disks, tape drives and/or flash drives. Such additional memory devices may be made accessible to the computing system environment 600 by means of, for example, a hard disk drive interface 612, a magnetic disk drive interface 614, and/or an optical disk drive interface 616. As will be understood, these devices, which would be linked to the system bus 606, respectively, allow for reading from and writing to a hard disk 618, reading from or writing to a removable magnetic disk 620, and/or for reading from or writing to a removable optical disk 622, such as a CD/DVD ROM or other optical media. The drive interfaces and their associated computer-readable media allow for the nonvolatile storage of computer readable instructions, data structures, program modules and other data for the computing system environment 600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 600.

A number of program modules may be stored in one or more of the memory/media devices. For example, a basic input/output system (BIOS) 624, containing the basic routines that help to transfer information between elements within the computing system environment 600, such as during start-up, may be stored in ROM 608. Similarly, RAM 610, hard drive 618, and/or peripheral memory devices may be used to store computer executable instructions comprising an operating system 626, one or more applications programs 628 (which may include the functional modules 116, 118, 120 and/or functionality disclosed herein, for example), other program modules 630, and/or program data 622. Still further, computer-executable instructions may be downloaded to the computing environment 600 as needed, for example, via a network connection.

An end-user may enter commands and information into the computing system environment 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus 606. Input devices may be directly or indirectly connected to processor 602 via interfaces such as, for example, a parallel port, game port, firewire, or a universal serial bus (USB). To view information from the computing system environment 600, a monitor 640 or other type of display device may also be connected to bus 606 via an interface, such as via video adapter 632. In addition to the monitor 640, the computing system environment 600 may also include other peripheral output devices, not shown, such as speakers and printers.

The computing system environment 600 may also utilize logical connections to one or more computing system environments. Communications between the computing system environment 600 and the remote computing system environment may be exchanged via a further processing device, such a network router 652, that is responsible for network routing. Communications with the network router 652 may be performed via a network interface component 654. Thus, within such a networked environment, e.g., the Internet, World Wide Web, LAN, or other like type of wired or wireless network, it will be appreciated that program modules depicted relative to the computing system environment 600, or portions thereof, may be stored in the memory storage device(s) of the computing system environment 600.

The computing system environment 600 may also include localization hardware 656 for determining a location of the computing system environment 600. In embodiments, the localization hardware 656 may include, for example only, a GPS antenna, an RFID chip or reader, a WiFi antenna, or other computing hardware that may be used to capture or transmit signals that may be used to determine the location of the computing system environment 600.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A method comprising:
determining a plurality of features of a plurality of items, the plurality of items accessible through an electronic interface;
applying a plurality of machine learning models to the determined features, wherein each of the machine learning models calculates a correlation of each feature to characteristic determinative of user selection on the electronic interface;
calculating respective Shapley values of each correlation determined by each of the plurality of machine learning models;
determining one or more of the item features that are most strongly correlated with the determinative characteristic according to the respective Shapley values; and
causing the electronic interface to be organized according to the determined most strongly correlated item features.

2. The method of claim 1, wherein causing the electronic interface to be organized according to the determined most strongly correlated item features comprises one or more of:
causing a filter to be provided for each of the determined most strongly correlated item features in the electronic interface; or
causing a respective value for each most strongly correlated item feature for each of the plurality of items to be displayed when the items are displayed on the interface.

3. The method of claim 1, wherein the plurality of machine learning models comprises:
a first model that outputs whether a correlation of each feature to the determinative characteristics is positive or negative; and
a second model that provides more accurate calculations of correlation than the first model.

4. The method of claim 3, wherein one or more of:
the first model comprises a linear regression model; or
the second model comprises a tree-based algorithm.

5. The method of claim 1, wherein the plurality of machine learning models comprises a first model and a second model, wherein:
the first model provides more accurate correlation calculations than the second model with respect to numerical features; and
the second model provides more accurate correlation calculations than the first model with respect to textual features.

6. The method of claim 5, wherein determining a plurality of features of a plurality of items comprises:
determining numerical features of each of the plurality of items; and
determining textual features of each of the plurality of items.

7. The method of claim 6, wherein determining textual features of each of the plurality of items comprises:
identifying, for each of the items, in a document associated with the item, zero or more textual strings, each textual string including text indicative of a respective feature; and
one or more of:
discarding textual strings that are greater than a threshold length;
discarding textual strings containing features with greater than a threshold quantity of possible values; or
discarding textual strings containing features occurring less than a threshold quantity of times in the plurality of items; and
designating features in the identified, non-discarded strings as the textual features.

8. The method of claim 1, further comprising:
receiving an interface navigation request from a user of the electronic interface;
determining one or more of the plurality of items to be displayed in response to the navigation request; and
displaying, in response to the navigation request, the determined one or more of the plurality of items to be displayed, including respective feature values for the determined most strongly correlated item features.

9. A system comprising:
a backend computing system comprising a non-transitory computer-readable memory storing instructions and a processor configured to execute the instructions to:
determine a plurality of features of a plurality of items, the plurality of items accessible through an electronic interface;
apply a plurality of machine learning models to the determined features, wherein each of the machine learning models calculates a correlation of each feature to characteristic determinative of user selection on the electronic interface;
calculate respective Shapley values of each correlation determined by each of the plurality of machine learning models;
determine one or more of the item features that are most strongly correlated with the determinative characteristic according to the respective Shapley values; and
a server in electronic communication with the backend computing system, the server configured to host the electronic interface and to organize the electronic interface according to the determined most strongly correlated item features.

10. The system of claim 9, wherein organizing the electronic interface according to the determined most strongly correlated item features comprises one or more of:
providing a filter for each of the determined most strongly correlated item features in the electronic interface; or
providing a respective value for each most strongly correlated item feature for each of the plurality of items when displayed on the interface.

11. The system of claim 9, wherein the plurality of machine learning models comprises:
a first model that outputs whether a correlation of each feature to the determinative characteristics is positive or negative; and
a second model that provides more accurate calculations of correlation than the first model.

12. The system of claim 11, wherein one or more of:
the first model comprises a linear regression model; or
the second model comprises a tree-based algorithm.

13. The system of claim 9, wherein the plurality of machine learning models comprises a first model and a second model, wherein:
the first model provides more accurate correlation calculations than the second model with respect to numerical features; and
the second model provides more accurate correlation calculations than the first model with respect to textual features.

14. The system of claim 13, wherein determining a plurality of features of a plurality of items comprises:
determining numerical features of each of the plurality of items; and
determining textual features of each of the plurality of items.

15. The system of claim 14, wherein determining textual features of each of the plurality of items comprises:
identifying, for each of the items, in a document associated with the item, zero or more textual strings, each textual string including text indicative of a respective feature; and
one or more of:
discarding textual strings that are greater than a threshold length;
discarding textual strings containing features with greater than a threshold quantity of possible values; or
discarding textual strings containing features occurring less than a threshold quantity of times in the plurality of items; and
designating features in the identified, non-discarded strings as the textual features.

16. The system of claim 9, wherein the server is further configured to:
receive an interface navigation request from a user of the electronic interface;
determine one or more of the plurality of items to be displayed in response to the navigation request; and
display, in response to the navigation request, the determined one or more of the plurality of items to be displayed, including respective feature values for the determined most strongly correlated item features.

17. A method comprising:
determining a plurality of features of a plurality of items, each item associated with a respective page of an electronic interface;
applying a plurality of machine learning models to the determined features, wherein each of the machine learning models calculates a correlation of each feature to characteristic determinative of user selection on the electronic interface;
determining one or more of the item features that are most strongly correlated with the determinative characteristic according to the machine learning models; and
causing a page of the electronic interface that includes at least two of the plurality of items to be organized according to the determined most strongly correlated item features.

18. The method of claim 17, further comprising:
calculating respective Shapley values of each correlation determined by each of the plurality of machine learning models;
wherein determining one or more of the item features that are most strongly correlated with the determinative characteristic according to the machine learning models is according to the Shapley values.

19. The method of claim 17, wherein the electronic interface is a website or an application.

20. The method of claim 17, wherein the plurality of machine learning models comprises:
a first model that outputs whether a correlation of each feature to the determinative characteristics is positive or negative; and
a second model that provides more accurate calculations of correlation than the first model.
